(19) United States
(12) Patent Application Publication
(10) Pub. No.: US 2013/0126601 A1
(43) Pub. Date: May 23, 2013

(54) Method and System for Registering and Scanning an ID Tag Linked to Information about a User

(71) Applicant: RuMe, Inc., Centennial, CO (US)

(72) Inventor: Jae S. Lee, Denver, CO (US)

(73) Assignee: RUME, INC., Centennial, CO (US)

(21) Appl. No.: 13/684,032

(22) Filed: Nov. 21, 2012

Related U.S. Application Data
(60) Provisional application No. 61/562,082, filed on Nov. 21, 2011.

(51) Int. Cl. G06F 17/30

(52) U.S. Cl. CPC G06F 17/30002
USPC 235/375

(57) ABSTRACT

Methods of registering an identification tag or image in association with a user and of displaying information associated with an identification tag or image. The method of registering includes receiving a request to access a web page corresponding to a web page address encoded within a quick response (QR) code or specified in text on the identification tag or image. The method further includes receiving information for each of the one or more fields of the type of the identification tag or image. The method of displaying information associated with an identification tag or image code includes receiving a request to access a web page corresponding to a web page address encoded within a QR code and transmitting the web page, if the QR code is registered. The transmitted web page includes information associated with an owner of the identification tag or image.

### CROSS REFERENCE TO RELATED APPLICATION

This application claims the benefit of U.S. Provisional Application No. 61/562,082, entitled “Method and System for Registering and Scanning a QR Code Linked to Information about a User” and filed Nov. 21, 2011, the contents of which application are incorporated herein by reference.

### FIELD OF THE INVENTION

The present invention relates, generally, to methods for storing and retrieving information and, more specifically, to a method and system for registering an identification tag in a database with information associated with a user and to a method and system for retrieving the information associated with the user from the database by scanning the identification tag or entering a web page address listed thereon.

### BACKGROUND OF THE INVENTION

Identification tags, cards, bracelets, etc. containing identification information are known in the art. Such identification devices may be worn by a user to alert a medical responder to important medical information for the user, or they may be worn by a pet to identify the pet's owner. For medical uses, such identification devices may contain a drug allergy of the user to alert the medical responder not to administer such drug to the user. Because these identification devices should be small enough to be worn or carried by the user, the amount of information contained on them is limited. Additionally, because these identification tags contain the user's information, they may compromise the user's privacy.

### SUMMARY OF THE INVENTION

In accordance with an aspect of the present invention, there is provided a method of processing a scanned identification tag. The method includes steps of: receiving a request to access a link provided on an identification tag, the identification tag associated with an identification tag type comprising one or more fields; receiving information for each of the one or more fields of the identification tag type associated with the identification tag from an owner of the identification tag, if the identification tag is not registered; and storing the received information in a database for access when the identification tag is scanned again. In accordance with an additional aspect, the method further includes steps of: receiving a further request to access the link provided on the identification tag; retrieving stored information corresponding to the identification tag, if the identification tag is registered; and transmitting portions of the stored information to a scanning user.

In accordance with another aspect of the present invention, there is provided a method of registering a quick response code in a database with information associated with a user. The method includes receiving a request to access a web page corresponding to a web page address encoded within a quick response (QR) code. The QR code is associated with a QR code type comprising one or more fields. The method further includes receiving information for each of the one or more fields of the QR code type associated with the QR code from the user, if the QR code is not registered. The received information is associated with the user and is stored in a database with the QR code.

In accordance with yet another aspect of the present invention, there is provided a method of displaying information associated with a QR code. The method includes receiving a request to access a web page corresponding to a web page address encoded within a QR code and displaying information associated with the QR code, if the QR code is registered. The method further includes accessing a database in which the QR code is stored in association with information associated with a user and transmitting the information associated with user in the web page.

### BRIEF DESCRIPTION OF THE DRAWINGS

For the purpose of illustration, there are shown in the drawings certain embodiments of the present invention. In the drawings, like numerals indicate like elements throughout. It should be understood that the invention is not limited to the precise arrangements, dimensions, and instruments shown. In the drawings:

FIG. 1 illustrates a networked computer system comprising a server and at least one computer system, in accordance with an exemplary embodiment of the present invention;

FIG. 2 illustrates an exemplary flow diagram of a method by which a user and the at least one computer system of FIG. 1 request and receive one or more identification tags or images, in accordance with an exemplary embodiment of the present invention;

FIG. 3 illustrates an exemplary flow diagram of a method by which the server of FIG. 1 receives the request of FIG. 2 and generates one or more identification tags or images in response to the request, in accordance with an exemplary embodiment of the present invention;

FIGS. 4A through 4D illustrate various products, each including an identification tag or image, in accordance with an exemplary embodiment of the present invention;

FIG. 5 illustrates an exemplary flow diagram of a method by which a user and the at least one computer system of FIG. 1 request registration of an identification tag or image with the server of FIG. 1 and by which a user and the at least one computer system retrieve shared information associated with an identification tag or image by scanning the identification tag or image or by inputting a web page address listed thereon, in accordance with an exemplary embodiment of the present invention; and

FIG. 6 illustrates an exemplary flow diagram of a method by which the server of FIG. 1 registers an identification tag or image and by which the server transmits shared information associated with an identification tag or image, in accordance with an exemplary embodiment of the present invention.

### DETAILED DESCRIPTION OF THE INVENTION

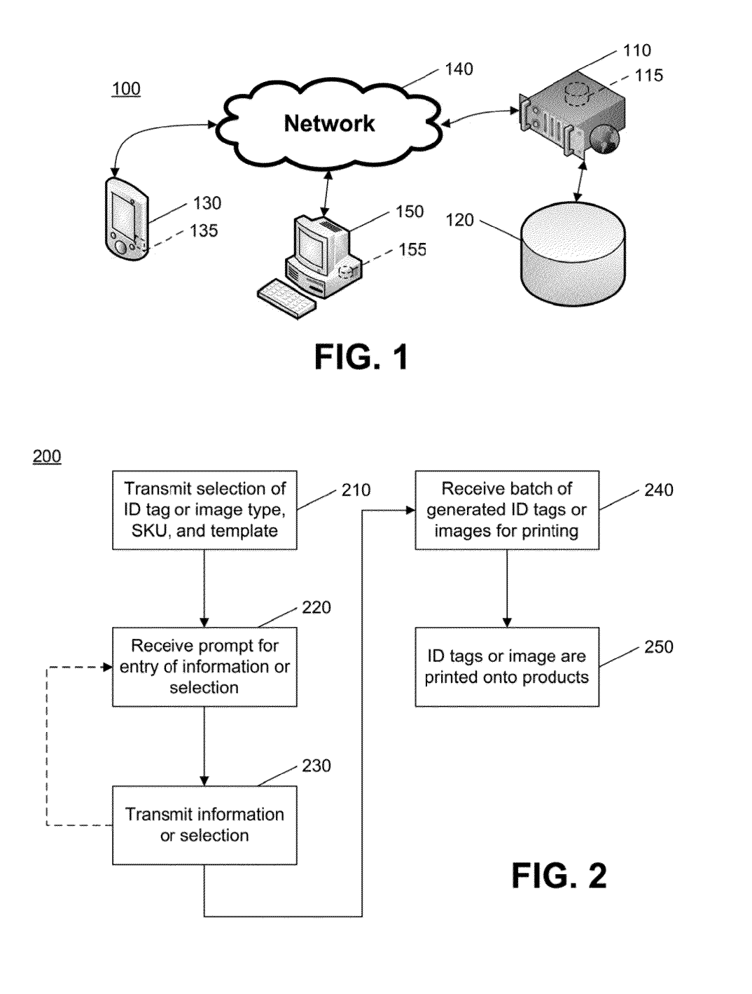

Illustrated in FIG. 1 is an exemplary networked computer system, generally designated as 100, in accordance with an exemplary embodiment of the present invention. The networked computer system 100 comprises a web server 110 connected to a plurality of remote computer systems, such as a mobile computer system 130 and a personal computer system 150, via a network 140. The web server 110 comprises an internal storage device 115, which may be a hard disk array, for storing software instructions for carrying out relevant portions of the methods described herein. The server 110 maintains a database 120 for storing data associated with identification (ID) tags or images, as described in further detail below. The database 120 may be internal to the server 110, in which case it is stored on the storage device 115, or it may be external to the server 110, in which case it may be stored on an external storage device, such as an external hard disk array. The mobile computer system 130 and the personal computer system 150 respectively comprise internal storage devices 135 and 155, which may be hard disk drives or solid state memories, for storing software instructions for carrying out relevant portions of the methods described herein.

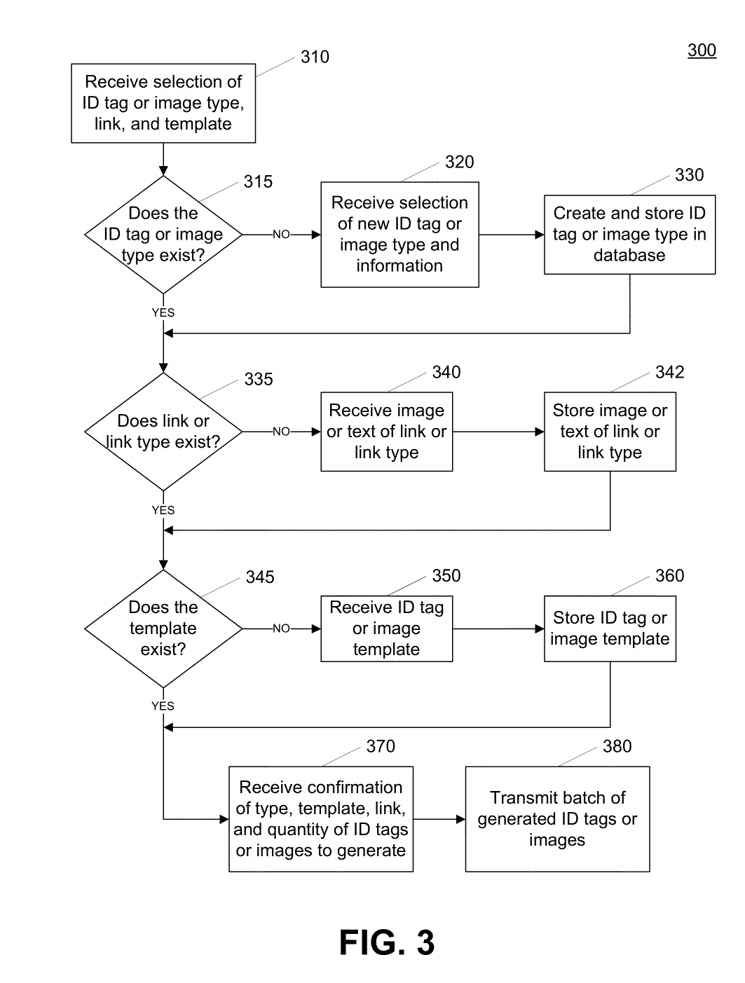

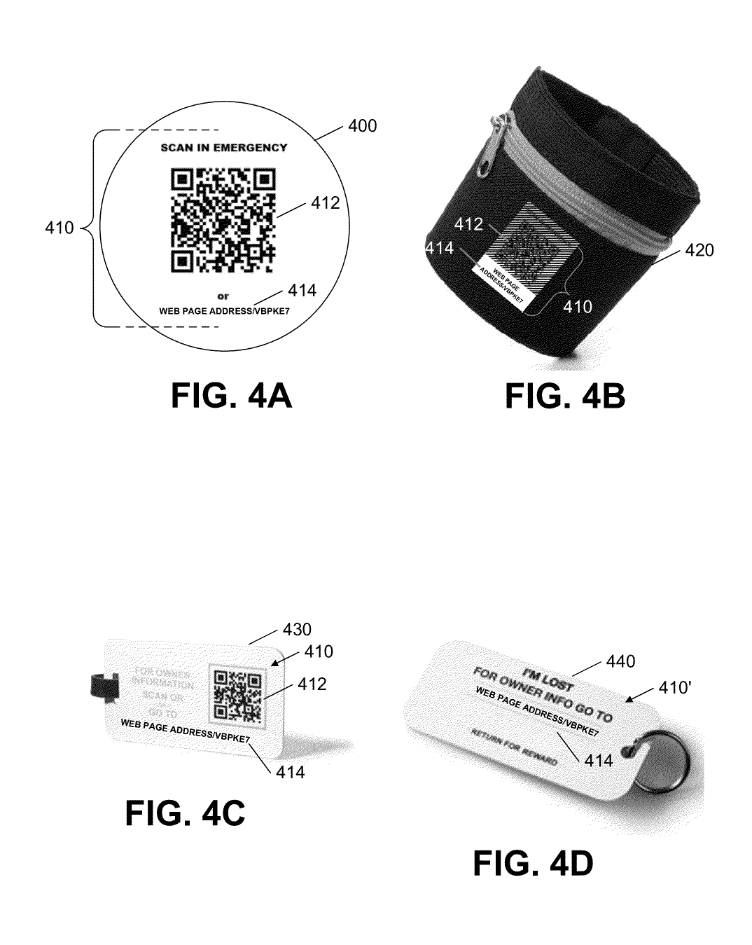

Illustrated in FIG. 2 is a flow diagram for a method, generally designated as 200, by which the mobile computer system 130 or the personal computer system 150 requests the generation of one or more ID tags or images, in accordance with an exemplary embodiment of the present invention. (Exemplary embodiments of ID tags or images are illustrated in FIGS. 4A through 4D.) Illustrated in FIG. 3 is a flow diagram for a method, generally designated as 300, by which the server 110 generates the one or more ID tags or images requested by the mobile computer system 130 or the personal computer system 150 in the method 200, in accordance with an exemplary embodiment of the present invention. Because the method 200 is performed by the computer system 130 or 150 and the method 300 is performed by the server 110, it is to be understood that portions of these methods 200 and 300 may be performed simultaneously by their respective computer systems.

The methods 200 and 300 are described below with reference to the computer system 150 and an administrator using the computer system 150. It is to be understood that the method 200 may be performed by either of the computer systems 130 and 150 or any other computer system. Further, although an exemplary embodiment of the method 200 is described with reference to an administrator interacting with the computer system 150, it is to be understood that other exemplary embodiments in which non-administrators interact with the computer system 150 during performance of the method 200 are contemplated.

Referring to FIGS. 1 through 3 together, the method 200 begins with a Step 210 in which the computer system 150 electronically transmits a selection of a type of an ID tag or image, a link or type of link, and a template for the ID tag or image in response to a selection by the administrator. The server 110 receives the selection of the type of ID tag or image, the link or type of link, and the template for the ID tag or image from the computer system 150, Step 310. A type of the ID tag or image is determined by types of data to be associated with the ID tag or image. As is described in further detail herein, the link is a link to shared information associated with the ID tag or image. The specification of a link is a specification of a stock-keeping unit (SKU), text of a web page address, or a QR code that is encoded with the web page address. The specification of a type of link is a specification of whether the link is an SKU, text of a web page address, or a QR code that is encoded with the web page address, in which case the actual link will be automatically generated by the server 110. Exemplary embodiments of ID tags or images in which the link is an SKU, web page address, or QR code, or any combination thereof are contemplated. In an exemplary embodiment, the SKU is the address for a web page to be hosted by the server 110. As used herein, the term, “fields,” may refer to the types of data associated with the ID tag or image type.

In an exemplary embodiment of the present invention, the ID tag or image may correspond to a personal identification record in the database 120 containing a person's name and contact information, such as address or telephone or cell phone number. The types of data are the person's name, contact information, etc. Thus, because the type of data identifies a person, the collection of these data types defines the ID tag or image type as personal identification information. Any of these data may be designated as shared information.

In another exemplary embodiment of the present invention, the ID tag or image may correspond to anonymous personal identification record in the database 120 containing non-shared information, such as a person's name and contact information (e.g., email address, home address, or telephone or cell phone number) and shared information, such as a third-party intermediary's contact information (e.g., email address, business address, or telephone or cell phone number). The types of data are the person's name, contact information, etc. and the third-party intermediary's contact information. In this exemplary embodiment, the third-party intermediary allows for contact of the person without revealing the identity of the person. Thus, because the type of data allows for contacting a person without revealing his or her identity, except to the third-party intermediary, the collection of these data types defines the ID tag or image type as anonymous personal identification information.

In yet another exemplary embodiment of the present invention, the ID tag or image may correspond to a medical record containing a patient's name, emergency contact information, allergies, etc. The types of data are the patient's name, emergency contact information, allergies, etc. Thus, because the types of data are medical, the collection of these data types defines the ID tag or image as to medical information.

The server 110 determines whether the selection of ID tag or image type received in the Step 310 exists, Step 315. If it does, the method 300 proceeds to a Step 335. Otherwise, if the ID tag or image type does not exist, the method proceeds to a Step 320, and the method 300 electronically prompts the computer system 150 to select a type of ID tag or image to be created, to input information about the ID tag or image type, and to input information about the fields (types of data) that will be contained within the ID tag or image type. The computer system 150 receives the prompt, Step 220, and the administrator selects the type of ID tag or image, inputs the information about the ID tag or image type, and inputs the information about the fields (types of data) that will be contained within the ID tag or image type. The computer system 150 electronically transmits the type of ID tag or image, the information about the ID tag or image type, the and the information about the fields (types of data) that will be contained within the ID tag or image type over the network 140 to the server 110, Step 230. The server 110 receives the type of ID tag or image, the information about the ID tag or image type, and the information about the fields (types of data) that will be contained within the ID tag or image type, Step 320. The information about the ID tag or image type may include a name for each field, a selection of the format of data (string, date, number, etc.) to be contained in each field, whether a field is publicly accessible (shared) or not (not shared), and whether the user who registers the ID tag or image may edit a field. The server 110 creates a record in the database 120 stores the new ID tag or image type and the information associated therein, Step 330, and the method 300 proceeds to the Step 335.

In the Step 335, the sever 110 determines whether the selection of the link or type of link received in the Step 310 exists. If the link or type of link does exist, the method 300 proceeds to a Step 345. Otherwise, the method 300 proceeds to a Step 340, in which the computer system 110 electronically prompts the computer system 150 to transmit an image of the link, such as a QR code, or text specifying the link or type of link, such as a web page address. The computer system 150 receives the prompt, Step 220, and the administrator provides an image or text of the link or text indentifying the type of link, which the computer system 150 electronically transmits in the Step 230 to the server 110. The server 110 receives the image of the link or the text specifying the link or type of link in the Step 340 and, in the Step 342, assigns the link to the ID tag or image code type received from the user in the Step 310. The server 110 stores the link in the record of the ID tag or image type in the database 120 in the Step 342 or in a separate record in the database 120. The method 300 continues to the Step 345.

In the Step 345, the server 110 determines whether the template of the ID tag or image type exists. If the template of the ID tag or image type does exist, the method 300 proceeds to a Step 370. Otherwise, the method 300 proceeds to a Step 350, in which the sever 110 electronically prompts the administrator to create the ID tag or image template. In the Step 350, the server 110 electronically prompts the administrator to specify how the ID tag or image will look, including positioning of the link, fonts, colors, backgrounds, etc. The computer system 150 receives the prompt, Step 220, and the administrator inputs the specifications of the ID tag or image template, which the computer system 150 electronically transmits in the Step 230 to the server 110. The server 110 receives them in the Step 350, and stores them in a record of the template in the database 120, Step 360. The method continues to the Step 370.

In the Step 370, the server 110 electronically prompts the administrator to confirm the selection of the ID tag or image type and template and the selection of the link and to specify the quantity of ID tags or images to generate. The computer system 150 receives the prompt, Step 220, and the administrator confirms the selection of the ID tag or image type and template and the selection of the link and provides the quantity of ID tags or images to generate, which the computer system 150 electronically transmits in the Step 230 to the server 110. The server 110 receives the selections, Step 370, and generates the ID tags or images and electronically offers them for download and printing, Step 380. If prompted by the administrator, the server 110 electronically transmits the ID tags or images in the Step 380. The computer system 150 receives the images, Step 240, and may print them onto final products, Step 250. The methods 200 and 300 are complete.

An example of an ID tag or image is illustrated in FIG.4A and is generally designated as 410, in accordance with an exemplary embodiment of the present invention. FIG. 4A illustrates the anonymous ID tag or image 410 applied to a decal 400, which may be affixed to an item of a user's choosing. The anonymous ID tag or image 410 comprises a QR code 412 and a website address 414. The QR code 412 is associated with the unique web page address 414, which is the SKU for the QR code 412. The ID tag or image 410 may be an anonymous ID tag or image or a non-anonymous ID tag or image.

Another example of an ID tag or image 410 applied to an item is illustrated in FIG.4B, in accordance with an exemplary embodiment of the present invention. FIG. 4B illustrates the ID tag or image 410 applied directly to a wristband 420, which may be worn by a user to provide a way to access information about the user using exemplary methods described herein. Yet another example of an ID tag or image 410 applied to an item is illustrated in FIG. 4C, in accordance with an exemplary embodiment of the present invention. FIG. 4C illustrates the ID tag or image 410 applied directly to a luggage tag 430, which may be attached to a piece of luggage to provide a way to access information about the owner using exemplary methods described herein.

Still another example of an ID tag or image is illustrated in FIG. 4D and is generally designated as 410′, in accordance with an exemplary embodiment of the present invention. FIG. 4D illustrates the ID tag or image 410′ applied to a key tag 440, which may be affixed to a key ring. The ID tag or image 410′ differs from the ID tag or image 410 in that it does not include the QR code 412. Instead, it includes only the web page address 414 to provide access to information of the owner of the key ring using exemplary methods described herein.

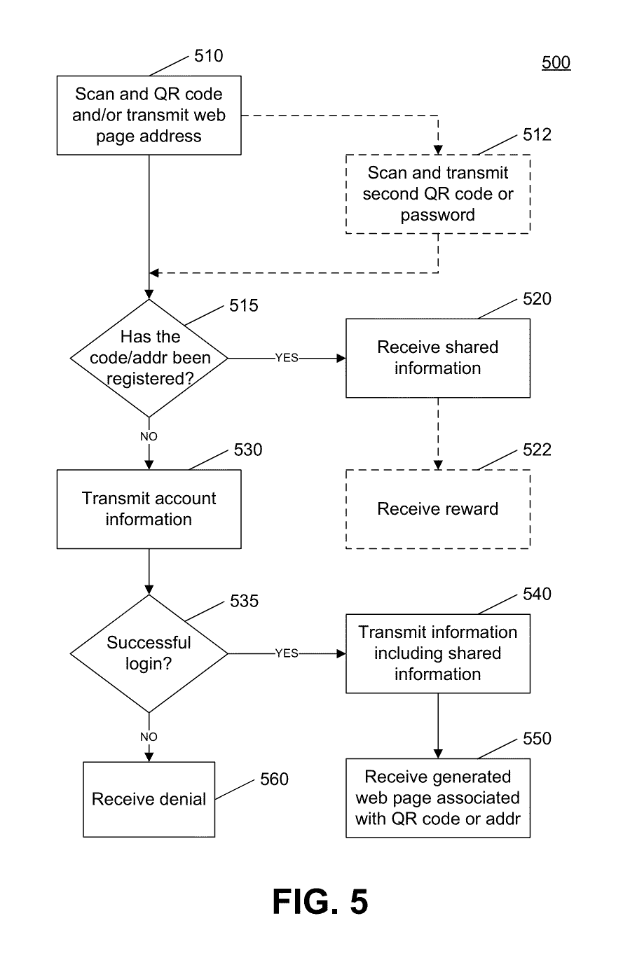

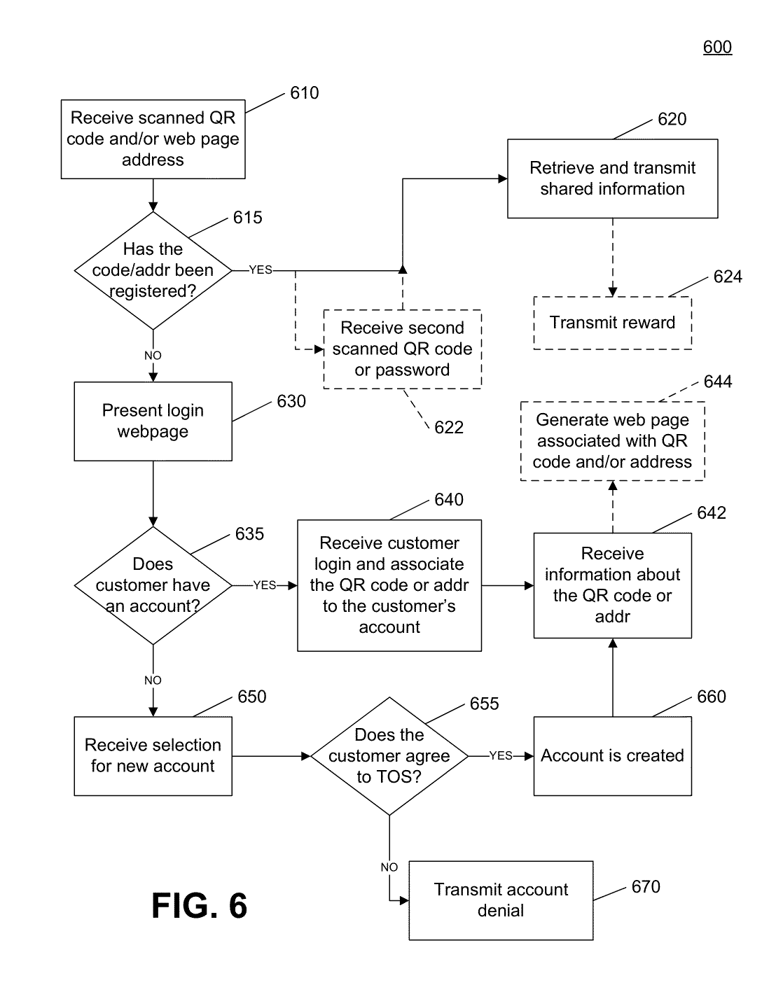

Illustrated in FIG. 5 is an exemplary flow diagram for a method, generally designated as 500, by which the computer system 130 or 150 registers the ID tag or image 410 or 410′ and/or retrieves shared information associated with the ID tag or image 410 or 410′, specifically information associated with the ID tag or image 410 or 410′ shared by the user who registered the ID tag or image 410 or 410′, in accordance with an exemplary embodiment of the present invention. Illustrated in FIG. 6 is a flow diagram for a method, generally designated as 600, by which the server 110 registers the ID tag or image 410 or 410′ and/or retrieves and transmits the shared information associated with the ID tag or image 410 or 410′ in response to a request, in accordance with an exemplary embodiment of the present invention. Because the method 500 is performed by the computer system 130 or 150 and the method 600 is performed by the server 110, it is to be understood that portions of these methods 500 and 600 may be performed simultaneously by their respective computer systems.

The methods 500 and 600 are described below with reference to the computer system 130 and a user using the computer system 130 to register the ID tag or image 410 or 410′, in which case such user may be the owner of the ID tag or image 410 or 410′ or a user using the computer system 130 to retrieve the shared information associated with the ID tag or image 410 or 410′, in which case the user might not be the owner of the ID tag or image 410 or 410′. It is to be understood that the method 500 may be performed by either of the computer systems 130 and 150 or any other computer system.

With reference to FIGS. 1, 4A-4D, 5, and 6, the method 500 begins with a Step 510 in which the computer system 130 receives a request to access the link on the ID tag or image 410 or 410′, for example either by scanning and receiving the QR code 412 or receiving a request to access the web page address 414. The computer system 130 may receive the QR code 412 as the result of the user thereof taking a picture of the QR code 412 with a digital camera. In the case of the computer system 130 being a smart phone, the smart phone may include a built-in camera capable of taking such a picture. The computer system 130 may receive the request to access the web page address 414 as a result of the user entering the web page address 414 into a web browser application executed on the computer system 130. The computer system 130 electronically and/or wirelessly transmits the request to access the link on the ID tag or image 410 or 410′ in the Step 510. The server 110 electronically receives the request to access the link, e.g., the QR code 412 or the web page address 414, Step 610.

The method 600 continues to a Step 615 in which the server 110 determines whether the ID tag or image 410 or 410′ (scanned QR code 412 or the web page address 414) (or its link) is registered, i.e., activated. The same determination is made by the computer system 130 in a Step 515. Alternatively, in the Step 515, the computer system 130 receives the result of the determination of the server 110 in the Step 615. If the server 110 determines that the ID tag or image 410 or 410′ (or its link) is registered, the method 600 continues to a Step 620, and the method 500 continues to a Step 520. Otherwise, the method 600 continues to a Step 630, and the method 500 continues to a Step 530.

In the Step 620, the server 110 retrieves and transmits the shared information associated with the link on the ID tag or image 410 or 410′. In an exemplary embodiment, the shared information is transmitted in an email to an email address specified by the scanning user, in a text message to a cell phone number specified by the scanning user, or in a web page linked by the ID tag or image 410 or 410′. The web page includes the shared information associated with the owner of the ID tag or image 410 or 410′ and stored in the database 120 in association with the ID tag or image 410 or 410′ (which information is stored in a Step 644 described below). The computer system 130 receives and displays the shared information, Step 520. In the exemplary embodiment in which the shared information is presented in a web page, the computer system 130 receives and renders the web page in a browser executed on the computer system 130 in the Step 520. The methods 500 and 600 then terminate.

In an exemplary embodiment, the web page is a static web page stored in a storage means, such as the hard drive 115, as an individual file or within the database 120. The web page includes the shared information associated with the user (which information is stored in a Step 644 described below). In such embodiment, the server 110 retrieves the web page from the storage means and electronically transmits it to the computer system 130 in the Step 620. In another exemplary embodiment, the web page is a dynamic web page stored in a storage means, such as the hard drive 115, as an individual file or within the database 120. In such embodiment, the dynamic web page, as stored, does not include the information associated with the user. When the dynamic web page is requested in the Step 510 and 610, the server 110 retrieves the dynamic web page from the storage means and dynamically includes the shared information associated with the owner associated with the ID tag or image 410 or 410′ (which information is stored in a Step 644 described below) from the database 420 and electronically transmits the dynamic web page to the computer system 130 in the Step 620.

If the server 110 determines in the Step 615 that the ID tag or image 410 or 410′ (or its link) is not registered, the method 600 proceeds to a Step 630, and the method 500 proceeds to a Step 530. In the Step 630, the server 110 electronically transfers a login web page over the network 140 to the computer system 130, which receives and renders the login web page in the Step 530. The user of the computer system 130 enters his or her login information, which the computer system 130 electronically transmits to the server 110 in the Step 530. If the user has an account and successfully logs in via the login web page, Step 535 or 635, the method 500 and the method 600 respectively proceed to Steps 540 and 640. In the Step 640, the server 110 accesses the database 120 and creates one or more new records associated with the user. The server 110 then prompts the user to input information for the various fields associated with the ID tag or image type of the ID tag or image 410 or 410′ containing the scanned QR code 412 or entered web page address 414, Step 642. In the Step 540, the user inputs such information into the computer system 130 and, optionally, designates which information is shared if the ID tag or image type permits designation of which information is shared. The computer system 130 electronically transmits the information, including the shared information, over the network 140 to the server 110 in the Step 540. The server 110 receives such information and creates a new record in the database 120 in the Step 642 associated with the ID tag or image 410 or 410′ and containing the information entered by the user.

In an exemplary embodiment, the method 600 proceeds to a Step 644 in which the server 110 then creates a web page which is associated with the ID tag or image 410 or 410′ and which contains the shared information. This web page may be static or dynamic, as described above. The web page may be stored in the hard drive 115, as an individual file or within the database 120. The methods 500 and 600 then terminate.

If the user does not have an account, the method 600 proceeds from the Step 635 to a Step 650, in which the server 110 prompts the user to select whether he or she would like to open an account. If the user indicates that he or she would like to open an account, the computer system 130 transmits such indication over the network 440 to the server 110, which receives such indication in the Step 650. The server 110 the presents the terms of service to the user in a Step 655. If the user agrees to the terms of service, the server 110 creates an account for the user and one or more new records associated with the user in the database 420, Step 660. The method continues to the Step 642 described above.

In the Step 655, if the user does not agree to the terms of service, the method 600 the proceeds to a Step 670 in which it terminates without the user creating an account or registering the ID tag or image 410 or 410′. The method 500 also proceeds from the Step 535 to the Step 550, in which the computer system 130 receives an indication that the user's account has been denied. The method 500 then terminates.

In an exemplary embodiment, the web page created in the Step 644 and linked to the ID tag or image 410 or 410′ contains shared information on how to contact the owner of the ID tag or image 410 or 410′. For example, if the ID tag or image 410 or 410′ is applied to the luggage tag 430 or key tag 440, the shared information may inform the user of the computer system 130 how to contact the owner of the luggage to which the luggage tag 430 is attached or the owner of the keys to which the key tag 440 is attached. Such information is the shared information transmitted in the web page by the server 110 in the Step 620. In an exemplary embodiment, the shared information may include an email address of the owner of the luggage or key tag 440 or contact information dependent on the owner's travel itinerary. In another exemplary embodiment, the shared information may include a form for contacting an intermediary who has access to the user's contact information associated with the ID tag or image 410 or 410′. Such form may include the item's recovery information, and below this information may be a form that allows the person who located the item to send the item owner or the intermediary an email (via a web form that does not reveal the item owner's email address) indicating that the item has been located, which email may include the name of the finder, location the item was located, and additional notes, without identifying the item owner's identity. The intermediary may arrange for the item to be collected from the finder and delivered to the owner. Thus, the owner's identity is maintained in privacy from another party who may find the item when lost.

In another exemplary embodiment, the stored information linked to the ID tag or image 410 or 410′ contains emergency medical information concerning a user wearing and item having the ID tag or image 410 or 410′, such as the wristband 420. Such emergency medical information may provide information regarding the user's medical allergies, medications currently being taken by the user, and emergency contact information, or other information which may be helpful to a first responder. If the owner of the ID tag or image 410 or 410′ were discovered in a medical emergency, a first responder or other good Samaritan may scan the owner's ID tag or image 410 or 410′ using the smart phone 130's camera to perform the Steps 510 through 520 of the method 500 (and to cause the server 110 to perform the Steps 610 through 620 of the method 600) to retrieve the owner's emergency medical information to assist in providing medical assistance to the owner. In an exemplary alternative embodiment, the product may contain a second QR code or a password (not illustrated) which serves as a password for the user's emergency medical information; the method 500 may further include a Step 512 of scanning the second QR code or transmitting the password; the method 600 may further include a Step 622 of receiving the scanned second QR code or receiving the password. If the second QR code or the password is correct for the QR code 412, the method 600 then continues to the Step 620, in which the shared information corresponding to the QR code 412 or web page address 414 and containing the emergency medical information is transmitted over the network 140 to the smart phone 130, which receives and displays the shared information. Such shared information may be contained in a text message, email message, or web page, in which case the smart phone 130 renders the web page, Step 520. Thus, the owner's medical data may be provided to a first provider and be protected against unwanted access.

In another exemplary embodiment, the method 600 provides a reward to a user who locates a lost item and either scans its QR code 412 or enters its web page address 414. In this exemplary embodiment, the method 600 proceeds from the Step 620 to a Step 624 in which the server 110 electronically transmits an indication to the smart phone 130 that the user has the option to claim a prize, such as a free digital decal containing an ID tag or image 410 or 410′. The smart phone 130 receives the prize indication via a web page transmitted by the server 110, and renders the web page, Step 522. The user enters his or her email address into a provided field in the web page on the smart phone 130, which electronically and/or wirelessly transmits it to the server 110 in the Step 522. The server 110 receives the email address in the Step 624 and electronically and/or wirelessly transmits the digital decal to the email address specified by the user, who can register it like the decal 400. The user may place the digital decal as the lock-screen or background image on the smart phone 130 in the Step 522 and register the ID tag or image 410 or 410′ thereof using the method 500.

As noted above, in an exemplary embodiment, the server 110 is a web server that is configured to host a plurality of web pages over the network 140. The plurality of web pages includes the web page through which an administrator requests the generation of the batch of ID tags or images in the method 200, by which a user registers an ID tag or image in the method 500, or by which a user accesses the shared information corresponding to a registered ID tag or image in the method 500. Each of such web pages is received by the computer system 130 or 150 and rendered by a browser executed by such computer system 130 or 150.

The computer system 130 may be a personal computer, such as a laptop computer, a tablet PC, a personal digital assistant (PDA), a smart phone, etc. The computer system 130 includes a user interface, such as a keyboard, key pad, or touch screen, for the user to input information prompted by the method 200 or 500 and a user interface, such as a screen, for displaying information provided by the method 200 or 500. In the embodiment illustrated in FIG. 1, the computer system 130 is a smart phone which includes a touch screen display/input and an internal camera.

The computer system 150 also may be a personal computer, such as a laptop computer, a tablet PC, a personal digital assistant (PDA), a smart phone, etc. The computer system 150 includes a user interface, such as a keyboard, key pad, or touch screen, for the user to input information prompted by the method 200 or 500 and a user interface, such as a screen, for displaying information provided by the method 200 or 500. In the embodiment illustrated in FIG. 1, the computer system 130 is a desktop computer which includes a display for displaying prompts and data to a user, e.g., administrator, and a keyboard for receiving input from the user (administrator).

It is to be understood that the user interface and/or the browser operating in the computer systems 130 and 150 are rendered and executed by the computer systems 130 and 150 upon loading and executing software code or instructions which are tangibly stored on a computer readable medium, such as on a magnetic medium, e.g., a computer hard drive 155, an optical medium, e.g., an optical disc, solid-state memory, e.g., flash memory 155, and other storage media known in the art. Thus, any of the functionality performed by the computer systems 130 and 150 described herein is implemented in software code or instructions which are tangibly stored on a computer readable medium, e.g., 135 or 155. Upon loading and executing such software code or instructions by the computer systems 130 and 150, the computer systems 130 and 150 may perform any of the functionality of the computer systems 130 and 150 described herein, including any steps of the methods 200 and 500 described herein.

In the exemplary embodiment illustrated in FIG. 1, there is illustrated one server which hosts the web pages described herein and which serves a plurality of web applications accessed by the computer systems 130 and 150 through the web pages. It is to be understood that more than one server may be used to implement the delivery of content to the computer systems 130 and 150 and the delivery of access of the computer systems 130 and 150 to the web applications. In a further exemplary embodiment, the server 110 comprises an application server, which executes the web applications and a web server, which delivers the web pages to the computer systems 130 and 150 and provides interfaces to the web applications to the computer systems 130 and 150 via software scripts embedded in the web pages.

The web applications also comprise software code or instructions which are tangibly stored on a computer readable medium, such as on a magnetic hard drive 115, optical drive, solid-state memory, and other storage media known in the art. Thus, any of the functionality performed by the server 110 described herein, such as hosting web applications or performing the methods 300 and 600, is implemented in software code or instructions which are tangibly stored on a computer readable medium, such as the hard drive array 115. Upon loading and executing such software code or instructions by the server 110, the server 110 may perform any of the functionality of the server 110 described herein including any steps of the methods 300 and 600 herein.

The term “software code” or “code” used herein refers to any instructions or set of instructions that influence the operation of a computer. They may exist in a computer-executable form, such as machine code, which is the set of instructions and data directly executed by a computer's central processing unit, a human-understandable form, such as source code, which may be compiled in order to be executed by a computer, or an intermediate form, such as object code, which is produced by a compiler. As used herein, the term “software code” or “code” also includes any human-understandable computer instructions or set of instructions that may be executed on the fly from a human-understandable form with the aid of an interpreter. Finally, the term “software script” or “script” used herein refers to any computer instructions or set of instructions that may interpreted but do not require compilation into machine code for execution by a computer.

These and other advantages of the present invention will be apparent to those skilled in the art from the foregoing specification. Accordingly, it is to be recognized by those skilled in the art that changes or modifications may be made to the above-described embodiments without departing from the broad inventive concepts of the invention. It is to be understood that this invention is not limited to the particular embodiments described herein, but is intended to include all changes and modifications that are within the scope and spirit of the invention.

What is claimed is:

1. A method of processing a scanned identification tag, the method comprising steps of:
receiving a request to access a link provided on an identification tag, the identification tag associated with an identification tag type comprising one or more fields;
receiving information for each of the one or more fields of the identification tag type associated with the identification tag from an owner of the identification tag, if the identification tag is not registered; and
storing the received information in a database for access when the identification tag is scanned again.

2. The method of claim 1, further comprising steps of:
receiving a further request to access the link provided on the identification tag;
retrieving stored information corresponding to the identification tag, if the identification tag is registered; and
transmitting portions of the stored information to a scanning user.

3. The method of claim 2, wherein the portions of the stored information are shared information.

4. The method of claim 3, wherein the shared information comprises contact information for an intermediary.

5. The method of claim 3, wherein the shared information comprises contact information for an owner of the identification tag.

6. A method of processing a quick response code, the method comprising steps of:
receiving a request to access a link encoded in a quick response (QR) code on an identification tag, the identification tag associated with an identification tag type comprising one or more fields;
receiving information for each of the one or more fields of the identification tag type associated with the identification tag from an owner of the identification tag, if the identification tag is not registered; and
storing the received information in a database for access when the identification tag is scanned again.

7. The method of claim 6, further comprising steps of:
receiving a further request to access the link encoded in the QR code;
retrieving stored information corresponding to the identification tag, if the identification tag is registered; and
transmitting portions of the stored information to a scanning user.

8. The method of claim 7, wherein the portions of the stored information are shared information.

9. The method of claim 8, wherein the shared information comprises contact information for an intermediary.

10. The method of claim 8, wherein the shared information comprises contact information for an owner of the identification tag.

11. A method of displaying information associated with a quick response code, the method comprising steps of:
receiving a request to access a web page corresponding to a web page address encoded within a quick response (QR) code; and
transmitting the web page, if the QR code is registered, the web page comprising information associated with a user.

12. The method of claim 11, further comprising a step of accessing a database in which the QR code is stored in association with the information associated with the user, wherein the step of transmitting comprises steps of:
dynamically the generating the web page to include the information associated with the user; and
transmitting the dynamically generated web page.

13. The method of claim 12, wherein the information is medical information associated with the user.
